(19) United States
(12) Patent Application Publication
(10) Pub. No.: US 2025/0136017 A1
(43) Pub. Date: May 1, 2025

(54) ACCESSORY HOLDER FOR CONNECTING AN ACCESSORY TO A SUPPORT

(71) Applicant: BOMBARDIER RECREATIONAL PRODUCTS INC., Valcourt (CA)

(72) Inventors: Marc-Andre L'HEUREUX, Bromont (CA); Abdelkarim MESKINE, Valcourt (CA); Mathieu HAMEL-GAGNON, Sherbrooke (CA)

(21) Appl. No.: 18/804,390

(22) Filed: Aug. 14, 2024

Related U.S. Application Data
(60) Provisional application No. 63/594,681, filed on Oct. 31, 2023.

(51) Int. Cl. B60R 11/00; B63B 17/00; B63B 34/10; F16M 11/12

(52) U.S. Cl. CPC B60R 11/00; B63B 34/10; F16M 11/126; B63B 2017/0054; F16M 2200/021

(57) ABSTRACT

An accessory holder for connecting an accessory to a support has an anchor being configured to be inserted in an aperture defined in the support and for selectively connecting the accessory holder to the support; an accessory connector connected to the anchor; and an accessory lock operatively connected to the anchor. The accessory connector being rotatable about a rotation axis. The accessory connector is configured for connecting to the accessory. With the accessory lock being locked, rotation of the accessory connector about the rotation axis is restricted. With the accessory lock being unlocked, rotation of the accessory connector about the rotation axis is permitted.

### CROSS-REFERENCE

The present application claims priority to U.S. Provisional Patent Application No. 63/594,681 filed Oct. 31, 2023, the entirety of which is incorporated herein by reference.

### TECHNICAL FIELD

The present technology relates to accessory holders for connecting accessories to supports.

### BACKGROUND

With the advent of portable digital cameras, an increasing number of drivers of vehicles mount such cameras to their vehicles in order to film their drives for entertainment and/or security purposes.

In order to mount the camera to the vehicle, a camera holder is needed. This typically consists of a bracket or other type of mount adapted to connect to the vehicle and a mechanism for connecting the camera to the bracket. The mechanism typically allows the adjustment of the angular position of a camera about one or more rotation axes, and in some cases, the linear position about one or more translation axes.

Many camera holders use screw clamps to permit the angular adjustments of the camera. Such screw clamps have a threaded fastener that when loosened allows the camera to be pivoted and when tightened set the angular position of the camera and prevent further movement. However, it can be inconvenient to the user to have to use this type of adjustment mechanism for setting every degree of freedom afforded by the camera holder, especially when wearing gloves.

Also, when the driver wants to remove the camera from the vehicle, the threaded fastener of one of the screw clamps needs to be completely removed, which is time consuming and could lead to the fastener being lost. Alternatively, the mechanism used to connect the camera to the bracket can be detached from the bracket or the bracket can be detached from the vehicle, which typically requires the use of tools and, as such, is inconvenient.

Furthermore, the driver may want to attach accessories other than cameras to the vehicle. This typically requires a substantially different mechanism for connecting this accessory to the bracket which is adapted to the accessory. The driver may also want to attach the camera/other accessory to different parts of the vehicle and/or to something other than the vehicle. This typically requires the use of a substantially different type of bracket or mount adapted to the location on the vehicle or to the other object to which the camera/other accessory is to be mounted. This can make it time consuming and inconvenient to move the camera/other accessory to a different part of the vehicle or to another object.

There is therefore a desire for an accessory holder that is convenient to adjust, install and remove.

### SUMMARY

It is an object of the present technology to ameliorate at least some of the inconveniences present in the prior art.

According to one aspect of the present technology, there is provided an accessory holder for connecting an accessory to a support. The support defines an aperture. The accessory holder has an anchor being configured to be inserted in the aperture defined in the support and for selectively connecting the accessory holder to the support; an accessory connector connected to the anchor; and an accessory lock operatively connected to the anchor. The accessory connector being rotatable about a rotation axis. The accessory connector is configured for connecting to the accessory. The accessory connector has a cylindrical portion received at least in part in the anchor. The cylindrical portion has a dentate surface. A central axis of the cylindrical portion is coaxial with the rotation axis. The accessory lock has a member connected to the anchor and a cam operatively connected to the anchor. The member has a dentate surface facing the dentate surface of the cylindrical portion. The dentate surface of the member is configured to engage the dentate surface of the cylindrical portion. The cam is movable between a locked position and an unlocked position. In the locked position of the cam, the cam presses the member against the cylindrical portion such that the dentate surface of the member engages the dentate surface of the cylindrical portion for restricting rotation of the accessory connector about the rotation axis. In the unlocked position of the cam, the cam applies less pressure against the member than in the locked position for permitting rotation of the accessory connector about the rotation axis.

In some embodiments, in the locked position, the accessory connector rotates about the rotation axis only in response to a torque greater than a first torque being applied to the cylindrical portion about the rotation axis. In the unlocked position, the accessory connector rotates about the rotation axis in response to a torque greater than a second torque being applied to the cylindrical portion about the rotation axis. The first torque is greater than the second torque.

In some embodiments, the cam has a deformable portion. In the locked position, in response a torque greater than the first torque being applied to the cylindrical portion, the cylindrical portion pushes the member against the cam and the deformable portion of the cam is deformed.

In some embodiments, the deformable portion is hollow.

In some embodiments, the dentate surface of the cylindrical portion has a plurality of rounded teeth.

In some embodiments, the dentate surface of the member has a plurality of rounded teeth.

In some embodiments, the member is an arcuate arm.

In some embodiments, the member is integrally formed with the anchor.

In some embodiments, the cam is pivotable between the locked position and the unlocked position.

In some embodiments, the cam is pivotable between the locked position and the unlocked position about an accessory lock axis. The accessory lock axis is parallel to the rotation axis.

In some embodiments, the accessory lock also has a lever connected to the cam for moving the cam between the locked position and the unlocked position.

In some embodiments, the lever is integrally formed with the cam.

In some embodiments, the lever and the cam are pivotable between the locked position and the unlocked position about an accessory lock axis. The accessory lock axis is parallel to the rotation axis.

In some embodiments, the anchor has: an anchor body configured to be received in the aperture of the support; and an anchor lock movably connected to the anchor body. The anchor lock has a locked position for connecting the anchor to the support. The anchor lock has an unlocked position for permitting removal of the anchor body from the aperture in the support and for permitting insertion of the anchor body in the aperture in the support.

In some embodiments, the anchor lock has an anchor lock lever for moving the anchor lock between the locked position and the unlocked position.

In some embodiments, the anchor lock has at least one anchor lock cam connected to and movable with the anchor lock lever. The anchor body has a portion disposed between the anchor lock lever and the at least one anchor lock cam.

In some embodiments, the anchor lock lever and the anchor lock cam are pivotable about an anchor lock axis between the locked position and the unlocked position. The anchor lock axis is parallel to the rotation axis.

According to another aspect of the present technology, there is provided an accessory holder for connecting an accessory to a support. The support defines an aperture. The accessory holder has: an anchor being configured to be inserted in the aperture defined in the support and for selectively connecting the accessory holder to the support; an accessory connector connected to the anchor, the accessory connector being rotatable about a rotation axis, the accessory connector being configured for connecting to the accessory; and an accessory lock operatively connected to the anchor. The accessory lock has an accessory lock lever operatively connected to the anchor. The accessory lock lever is movable between a locked position and an unlocked position. In the locked position of the accessory lock lever, the accessory lock restricts rotation of the accessory connector about the rotation axis. In the unlocked position of the accessory lock lever, the accessory lock permits rotation of the accessory connector about the rotation axis. The anchor has: an anchor body configured to be received in the aperture of the support; and an anchor lock movably connected to the anchor body. The anchor lock has an anchor lock lever operatively connected to the anchor. The anchor lock lever is movable between a locked position and an unlocked position. The locked position of the anchor lock lever is for connecting the anchor to the support. The unlocked position of the anchor lock lever is for permitting removal of the anchor body from the aperture in the support and for permitting insertion of the anchor body in the aperture in the support.

In some embodiments, the accessory lock lever is pivotable about an accessory lock axis between the locked position and the unlocked position. The anchor lock lever is pivotable about an anchor lock axis between the locked position and the unlocked position. The accessory lock axis and the anchor lock axis are parallel to the rotation axis.

In some embodiments, the accessory lock lever pivots in a first direction from the locked position to the unlocked position. The anchor lock lever pivots in a second direction from the locked position to the unlocked position. The first direction is opposite the second direction.

In the context of the present specification, unless expressly provided otherwise, the words “first,” “second,” “third,” etc. have been used as adjectives only for the purpose of allowing for distinction between the nouns that they modify from one another, and not for the purpose of describing any particular relationship between those nouns.

It must be noted that, as used in this specification and the appended claims, the singular form “a,” “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a watercraft, such as “vertical”, “horizontal”, “forwardly”, “rearwardly”, “left”, “right”, “above” and “below”, are as they would be understood by a driver of the watercraft sitting thereon in an upright driving position, with the watercraft steered straight-ahead in a neutral trim position and being at rest in calm water.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a front left side of a personal watercraft;

FIG. 2 is a top plan view of the personal watercraft of FIG. 1;

FIG. 3 is a left side elevation view of the personal watercraft of FIG. 1;

FIG. 4 is a front elevation view of the personal watercraft of FIG. 1;

FIG. 5 is a cross-sectional view taken through line 5-5 of FIG. 2 of the personal watercraft of FIG. 1;

FIG. 6 is a perspective view, taken from a rear, left side, of an accessory holder assembly of the watercraft of FIG. 1, with an anchor lock of an anchor of an accessory holder of the accessory holder assembly being in a locked position and an accessory lock of the accessory holder being in a locked position;

FIG. 7 is a right side elevation view of the accessory holder assembly of FIG. 6;

FIG. 8 is a cross-sectional view taken through line 8-8 of FIG. 7 of the accessory holder assembly of FIG. 6;

FIG. 9 is a front view of the accessory holder assembly of FIG. 6;

FIG. 10 is a cross-sectional view taken through line 10-10 of FIG. 9 of the accessory holder assembly of FIG. 6;

FIG. 11 is a cross-sectional view taken through line 11-11 of FIG. 9 of the accessory holder assembly of FIG. 6;

FIG. 12 is a perspective view, taken from a rear, left side, of the accessory holder assembly of FIG. 6, with the anchor lock being in an unlocked position and the accessory lock of the accessory holder being in an unlocked position;

FIG. 13 is a rear view of the accessory holder assembly of FIG. 12;

FIG. 14 is a cross-sectional view taken through line 14-14 of FIG. 13 of the accessory holder assembly of FIG. 12;

FIG. 15 is a perspective view, taken from a rear, left side, of the accessory holder assembly of FIG. 6, with an accessory of the accessory holder assembly rotated relative to the accessory holder;

FIG. 16 is an exploded perspective view, taken from a rear, left side, of the accessory holder assembly of FIG. 6;

FIG. 17 is an exploded perspective view, taken from a front, left side, of the accessory holder assembly of FIG. 6;

FIG. 18 is a perspective view, taken from a rear, left side, of an alternative embodiment of the accessory holder of FIG. 6;

FIG. 19 is a perspective view, taken from a front, left side, of the accessory holder of FIG. 18;

FIG. 20 is a rear view of the accessory holder of FIG. 18; and

FIG. 21 is a cross-sectional view taken through line 21-21 of FIG. 20 of the accessory holder of FIG. 18.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

An accessory holder 100 according to the present technology will be described with reference to a personal watercraft 10. It is contemplated that aspects of the present technology could be used in watercraft of another type or in other vehicles, for example, cars, truck, all-terrain vehicles (ATVs), snowmobiles, motorcycles, three-wheeled road vehicles, side-by-side off-road vehicles (SSVs), small aircraft, and hydrofoils boards. It is also contemplated that the accessory holder of the present technology could be used in combination with things other than vehicles such as, for example, desks, workbenches, and tripods.

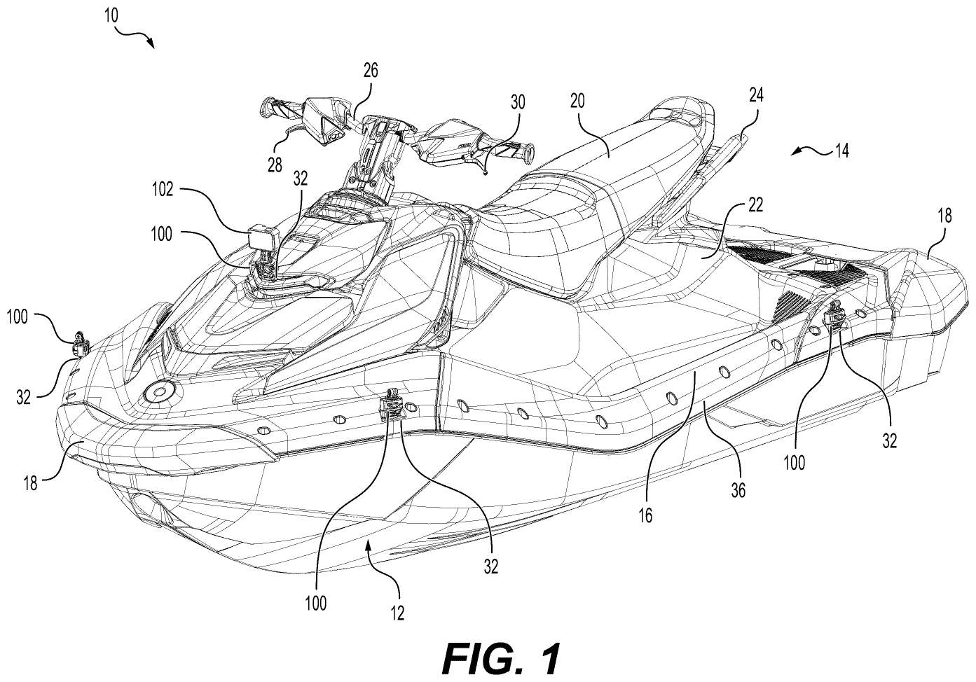

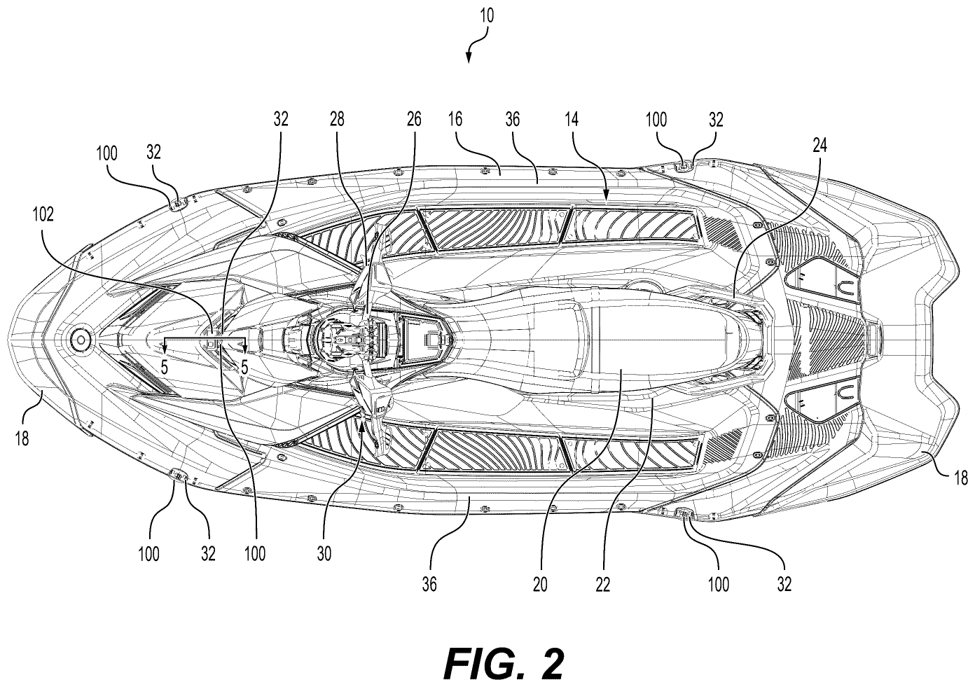

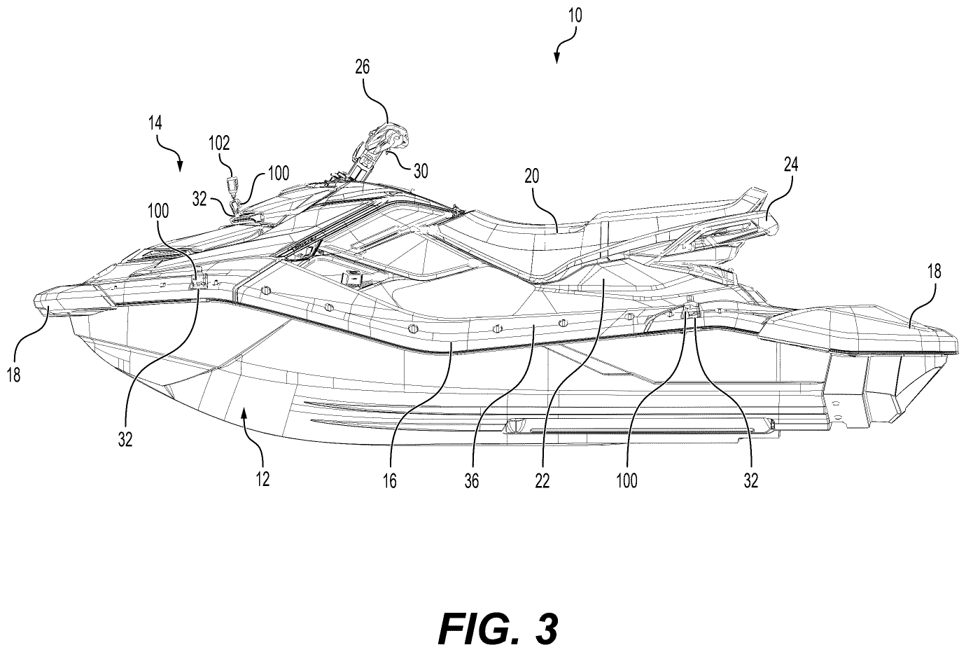

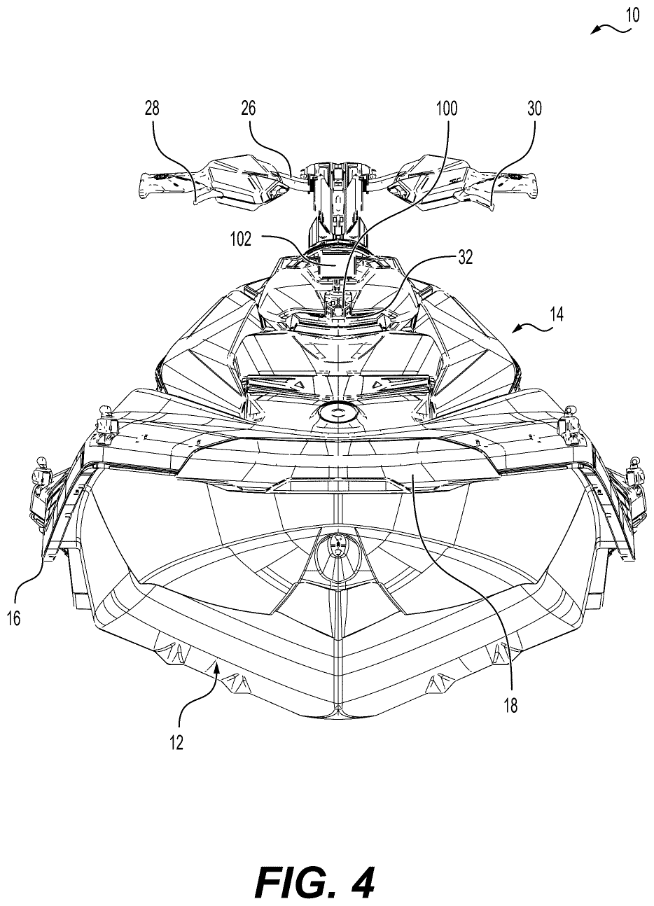

FIGS. 1 to 5 illustrate the personal watercraft 10. The personal watercraft 10 has a watercraft body made of two main parts. These parts are the hull 12 and the deck 14, which is disposed on the hull 12. The hull 12 buoyantly supports the watercraft 10 in the water. The deck 14 is designed to accommodate a driver and two passengers. It is contemplated that in alternative embodiments, the deck 14 could accommodate only the driver, the driver and one passenger, or the driver and more than two passengers. The hull 12 and deck 14 are joined together by fasteners, more particularly screws. Adhesive and other types of fasteners, such as bolts or rivets may also be used to join the hull 12 to the deck 14. The portions of the watercraft 10 where the hull 12 and the deck 14 joined form an outwardly extending flange 16. Bumpers 18 cover the front and rear portions of the flange 16. The volume created between the hull 12 and the deck 14 is known as the motor compartment. The motor compartment accommodates the engine (not shown) as well as the muffler, exhaust pipe, gas tank, electrical system (battery, electronic control unit, etc.), air box, storage bins and other elements required by or desired for the watercraft 10. In an alternative embodiment, the motor compartment may alternatively accommodate an electric motor, batteries, and associated components instead of the previously mentioned component should the watercraft 10 be an electric personal watercraft 10.

The deck 14 has a centrally positioned straddle-type seat 20 placed on top of a pedestal 22 to accommodate a rider in a straddling position. A grab handle 24 is provided between the pedestal 22 and the straddle-type seat 20 at the rear of the straddle-type seat 20 to provide a handle onto which a passenger may hold on. The seat 20 is removably attached to the pedestal 22 by a hook and tongue assembly (not shown) at the front of the seat 20 and by a latch assembly (not shown) at the rear of the seat 20, or by any other known attachment mechanism. The seat 20 covers a motor access opening (not shown), defined by a top portion of the pedestal 22, which provides access to the engine (not shown).

The engine drives a jet propulsion unit (not shown) for propelling the watercraft 10. The jet propulsion unit includes a steering nozzle (not shown) for redirecting a jet of water expelled from the jet propulsion unit. The steering nozzle is operatively connected to a handlebar 26 provided forward of the seat 20. A throttle lever 28 provided on a right side of the of the handlebar 26 controls an operation of the engine, and thereby a speed of the watercraft 10. A reverse lever 30 provided on a left side of the handlebar 26 controls an operation of a reverse gate (not shown) operatively connected to the jet propulsion unit for reversing a direction of travel of the watercraft 10. In some embodiments, in addition to controlling operation of the reverse gate, the reverse lever 30 simultaneously controls operation of the engine in order to brake and reverse the watercraft 10.

The flange 16 defines two apertures 32 on each side of the watercraft 10. Another aperture 32 is defined in the deck 14 forward of the handlebar 26 at a lateral center of the watercraft 10. Each aperture 32 extends vertically and is shaped to receive an accessory holder 100. In the present embodiment, each aperture 32 has a hexagonal shape as viewed from above, but other shapes are contemplated. On the left and right sides of the watercraft 10, portions of the deck 14 adjacent to the flange 16 and extending upward from the flange 16 define gunnels 34. It is contemplated that one or more apertures 32 could be defined in the gunnels 34 or in other parts of the deck 14.

In FIGS. 1 to 5, five accessory holders 100 are received in the five apertures 32. It is contemplated that less accessory holders 100 could be provided. It is also contemplated that all of the accessory holders 100 could be removed should they not be needed during certain operations of the watercraft 10. The four accessory holders 100 provided in the apertures 32 defined in the flange 16 do not have an accessory connected to them. The accessory holder 32 defined in front the handlebar 26 connects an accessory 102, which in this embodiment is a portable digital camera 102, to the deck 14. Any one of the five accessory holders 100 could be received in any one of the apertures 32.

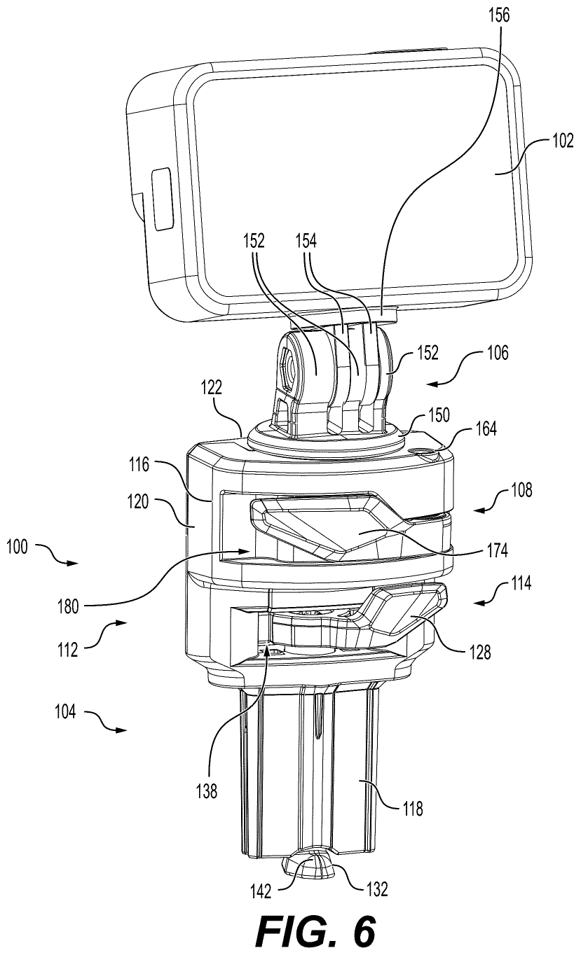

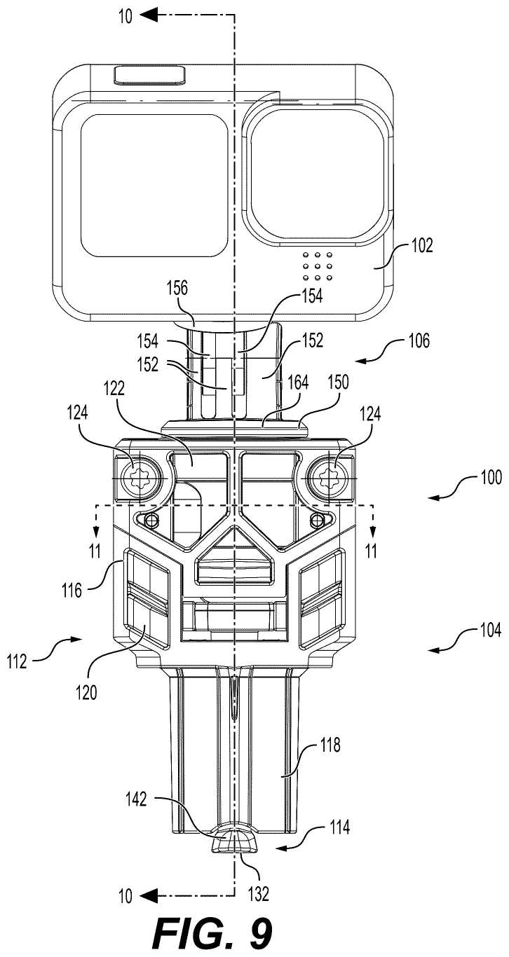

Turning now to FIGS. 6 to 17, an accessory holder assembly, consisting of the accessory holder 100 and the camera 102 connected to it, will be described in more detail. The other accessory holders 100 are the same and will not be described separately. In the description of the accessory holder 100 provided below, terms related to spatial orientation are in reference to the accessory holder 100 being installed in the aperture 32 defined in the lateral center of the deck 14 forward of the handlebar 26 as shown in FIGS. 1 to 5. As would be understood, terms related to spatial orientation would vary with respect to the frame of reference of the watercraft 10 depending on where the accessory holder 100 is placed on the watercraft. For example, when the accessory holder 100 is installed in one of the apertures 32 defined in the flange 16, the side referred to as the front in the description below would become the left or right side in the frame of reference of the watercraft 10. The accessory holder 100 could also be installed in the aperture 32 defined in the lateral center of the deck 32 forward of the handlebar 26 in an orientation that is 180 degrees from the one illustrated in FIGS. 1 to 5, such that the front, back, left and right sides in the description below would become back, front, right and left sides respectively in the frame of reference of the watercraft 10.

The accessory holder 100 is configured to connect a camera 102 to a support. In the present embodiment, the support is the watercraft 10 itself, or more specifically any one of the portions of the watercraft 10 defining an aperture 32. It is contemplated that the support could be a dedicated support having one or more apertures having the same characteristics as the apertures 32. For example, the support could be a rail having one or more apertures like the apertures 32, and this rail could be mounted to the watercraft 10, another vehicle or another object altogether. It is contemplated that in vehicles such as ATVs, the support could be a storage rack having one or more apertures like the apertures 32. This allows the accessory holder 100 to be installed on the watercraft 10 as described below, but to also be removed from the watercraft 10 and be installed on any other support having at least one aperture having the same characteristics as the apertures 32.

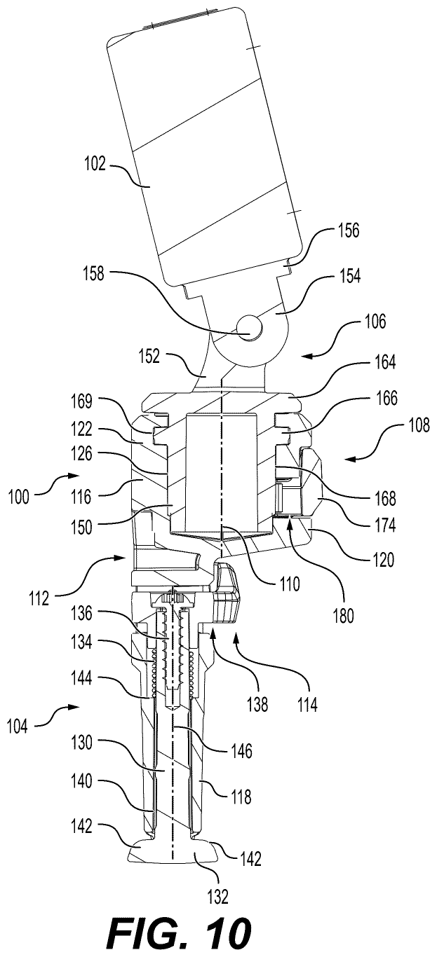

The accessory holder 100 has an anchor 104, an accessory connector 106 and an accessory lock 108. The anchor 104 is configured to be inserted in the aperture 32 and to selectively connect the accessory holder 100 to the watercraft 10. The accessory connector 106 is connected to the anchor 104 and is configured to connect to the camera 102. The accessory connector 106 is rotatable about a rotation axis 110 (see FIGS. 10, 11 and 14) relative to the anchor 104. The accessory lock 108 is operatively connected to the anchor 104. The accessory lock 108 restricts or permits rotation of the accessory connector 106 about the rotation axis 110 as will be described below.

The anchor 104 will now be described in more detail. The anchor 104 has an anchor body 112, and an anchor lock 114 movably connected to the anchor body 112. The anchor body 112 has a head portion 116 and a post 118 extending downward from the head portion 116. The head portion 116 has a main portion 120 and a cover 122. The cover 122 is fastened by screws 124 to the main portion 120. The post 118 is integrally formed with and extends downward from the main portion 120 of the head portion 116. The main portion 120 and the cover 122 define a recess 126 therebetween. The recess 126 is shaped to receive a portion of the accessory connector 106 as will be described in more detail below. The post 118 is shaped for being received in the aperture 32 defined in the watercraft 10. In the present embodiment the post 118 has a generally hexagonal cross-section. It is contemplated that the cross-section of the post 118 could have a different shape, in which case the aperture 32 would have a corresponding shape. The post 118 and the aperture 32 are shaped such that the post 118 cannot rotate in the aperture 32. The head portion 116 is longer and wider than the post 118.

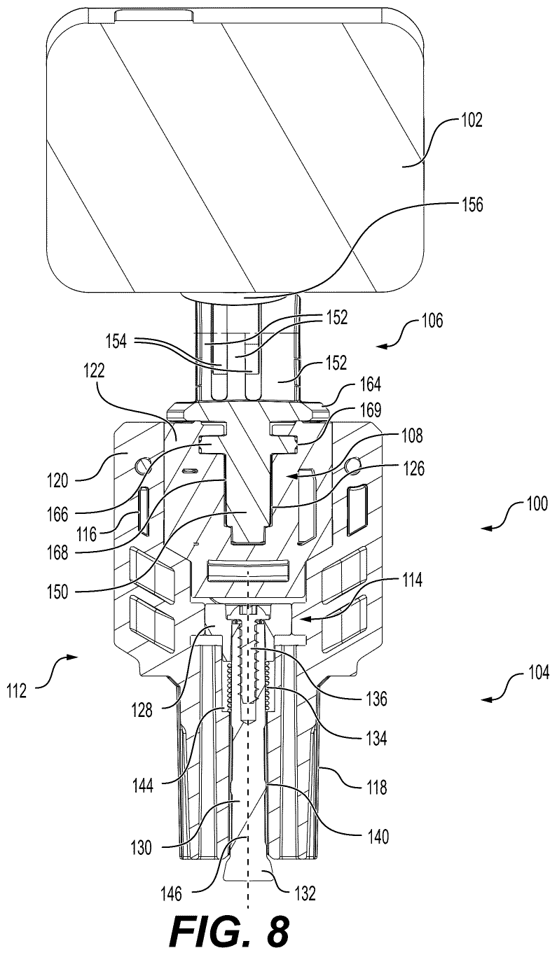

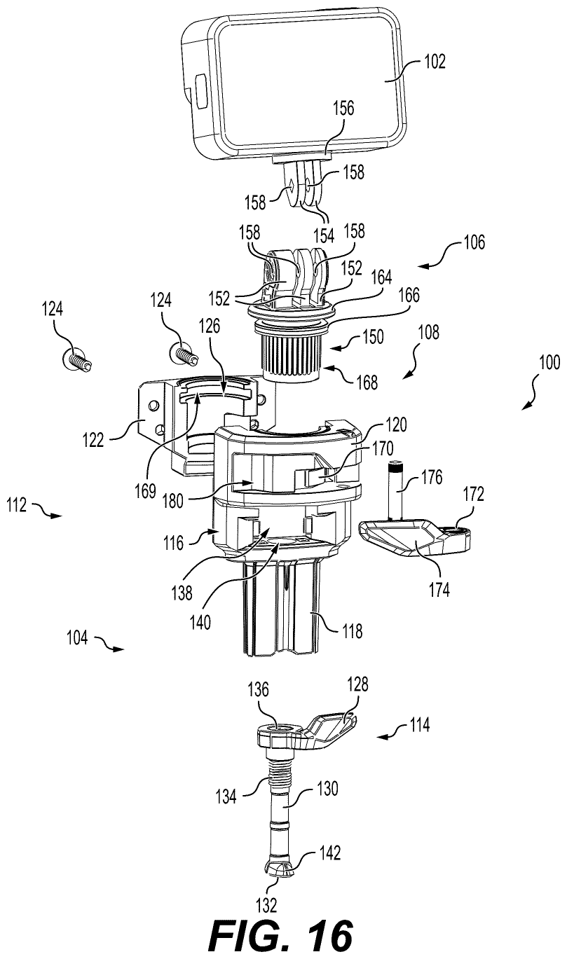

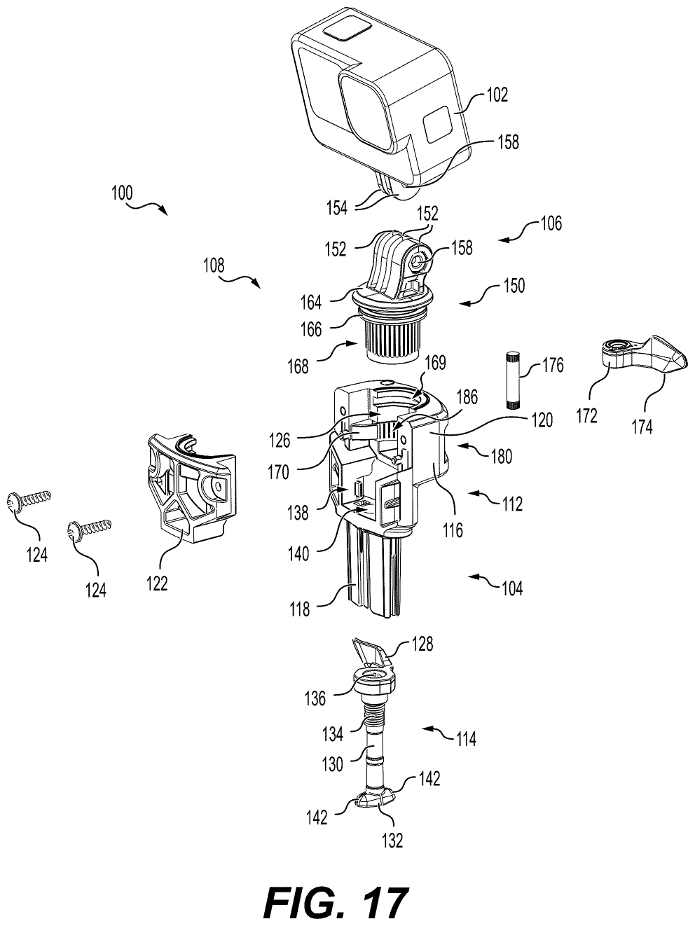

The anchor lock 114 includes an anchor lock lever 128 (hereinafter the lever 128), a shaft 130 connected to the lever 128, a cam member 132 connected to the shaft 130, a spring 134 and a screw 136. The lever 128 is received in a recess 138 defined in the main portion 120 of head portion 116 of the anchor body 112. The shaft 130 is received in a passage 140 defined in the post 118 of the anchor body 112. The screw 136 fastens the lever 128 to the shaft 130. The cam member 132 is connected to the lower end of the shaft 130. In the present embodiment, the cam member 132 is integrally formed with the shaft 130, but it is contemplated that the cam member 132 could be connected to the shaft 130 differently, such as by a threaded fastener for example. The cam member 132 is disposed below the lower end of the post 118 of the anchor body 112. As such, the post 118 is disposed between the lever 128 and the cam member 132. The cam member 132 is generally hexagonal, as seen in FIGS. 16 and 17, but other shapes are contemplated. The cam member 132 defines two anchor lock cams 142. The spring 134 is disposed inside the passage 140 around the shaft 130. The spring 134 abuts a step 144 (FIGS. 8 and 10) defined in the passage 140 and a lower end of the lever 128 so as to bias the lever 128 away from the post 118. As a result, the cam member 132 is biased toward the lower end of the post 118.

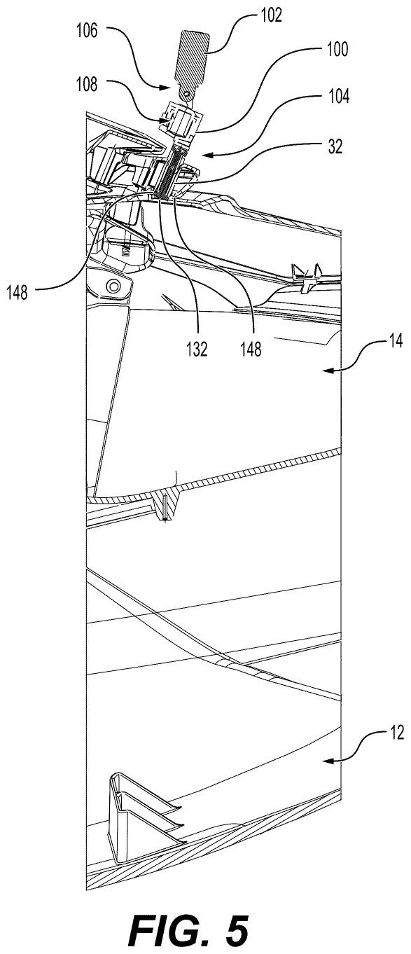

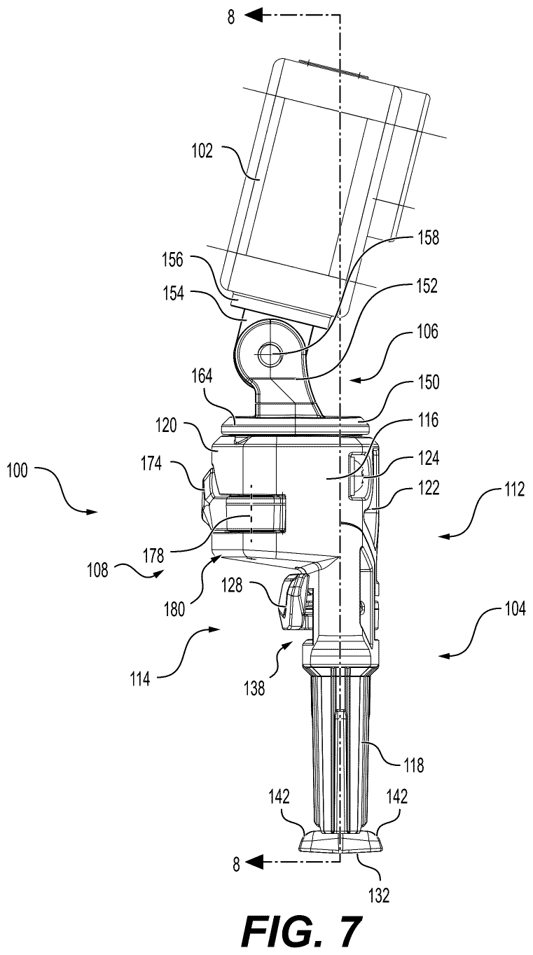

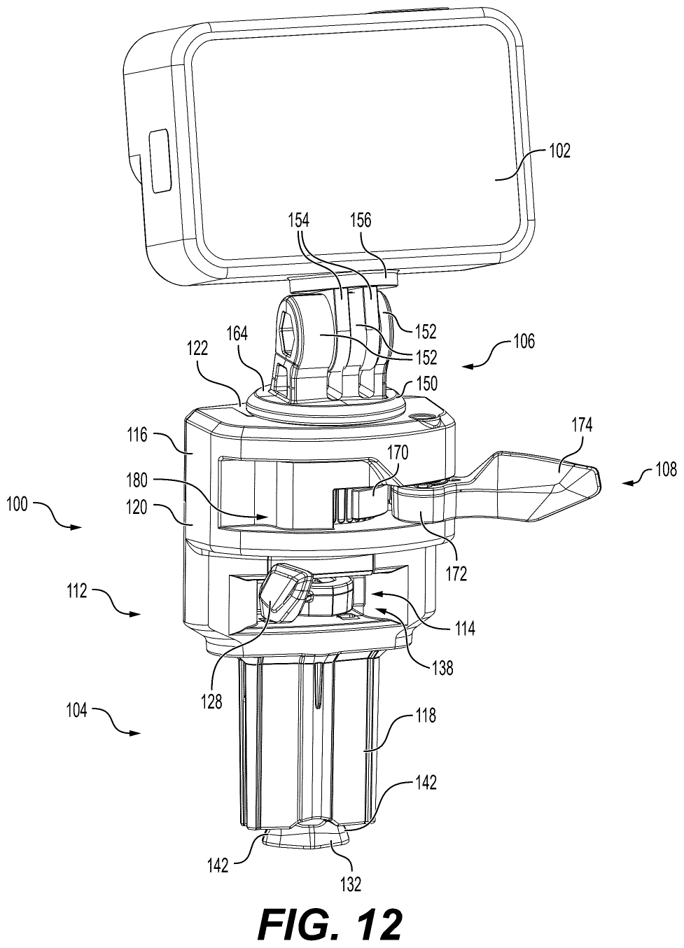

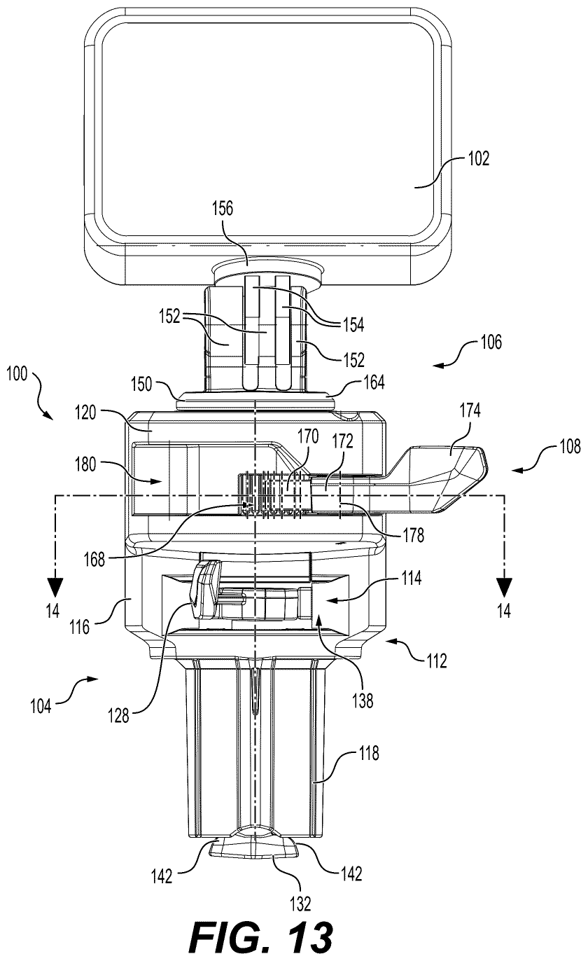

The lever 128 is used to move the anchor lock 114 between a locked position and an unlocked position. As the lever 128 is pivoted about an anchor lock axis 146 corresponding to the longitudinal axis of the shaft 130, the shaft 130 and the cam member 132 pivot together with the lever 128 about the axis 146. The anchor lock axis 146 is parallel to the rotation axis 110. In the unlocked position shown in FIGS. 12 and 13, the cam member 132 is contained within the perimeter of the post 118 as viewed from below. Since in the unlocked position the cam member 132 does not protrude longitudinally or laterally from the post 118, the unlocked position of the anchor lock 114 permits insertion of the post 118 of the anchor body 112 into the aperture 32 and permits removal of the post 118 of the anchor body 112 from the aperture 32. In the locked position shown in FIGS. 6 to 10 and 15, the lever 128 and the cam member 132 are turned 90 degrees from their orientations in the unlocked position. As a result, the cam member 132 protrudes longitudinally from the post 118 as best seen in FIG. 7. When the post 118 is inserted in the aperture 32 and the anchor lock 114 is moved to its locked position, as the cam member 132 rotates, the cams 142 engage downwardly facing surfaces 148 (FIG. 5) adjacent to the lower end of the aperture 32. As a result, the cam member 132, the shaft 130 and the lever 128 move down slightly, thereby compressing the spring 134. The spring 134 thus biases the cams 142 against the surfaces 148, thereby firmly pressing the head portion 116 of the anchor body 112 against the deck 14, thereby connecting the anchor 104 to the watercraft 10. Friction between the cams 142 and the surfaces 148 prevent the anchor lock 114 from being easily returned to the unlocked position. In some embodiments, the surfaces 148 define small indentations for receiving the cams 142 when the ancho lock 114 is in the locked position, thereby further helping to prevent the ancho lock 114 from being accidentally returned to the unlocked position. It is contemplated that an anchor that is different from the anchor 104 described above could be used to connect the accessory connector 106 to the watercraft 10.

The accessory connector 106 will now be described in more detail. As best seen in FIGS. 6, 16 and 17, the accessory connector 106 has a cylindrical portion 150, three arms 152 extending from a top of the cylindrical portion 150, two arm 154 extending in the spaces defined between the three arms 152, and a plate 156 connected to the top of the arms 154.

The plate 156 has a threaded fastener (not shown) extending from a top thereof that is threaded into a threaded aperture (not shown) defined in a bottom of the camera 102 to connect the camera 102 to the accessory connector 106. This threaded aperture is standard on most portable cameras and is often referred to as a tripod thread or a tripod socket, as it is provided to connect the camera to a tripod. Each of the arms 152, 154 defines an aperture 158. A threaded fastener (not shown) is inserted through the apertures 158 and a nut (not shown) is fastened to the end of the threaded fastener such that the arms 152, 154 are between the head of the fastener and the nut. When the fastener is loosened, the arms 154 and the plate 156, and therefore the camera 102, can be pivoted about the axis of the fastener allowing adjustment of a pitch of the camera 102. When the camera 102 is in the desired position, the fastener is tightened, thereby squeezing the arms 152, 154 between the head of the fastener and the nut, thereby restricting movement of the arms 154, the plate 156 and the camera 102 about the axis of the fastener. It is contemplated that another type of mechanism could be provided between the plate 156 and the cylindrical portion 150 to permit adjustment of the pitch of the camera 102. It is also contemplated that a rigid arm could be connected between the plate 156 and the cylindrical portion 150 instead of the arms 152, 154, thereby resulting in an accessory connector that does not permit adjustment of the pitch of the camera 102.

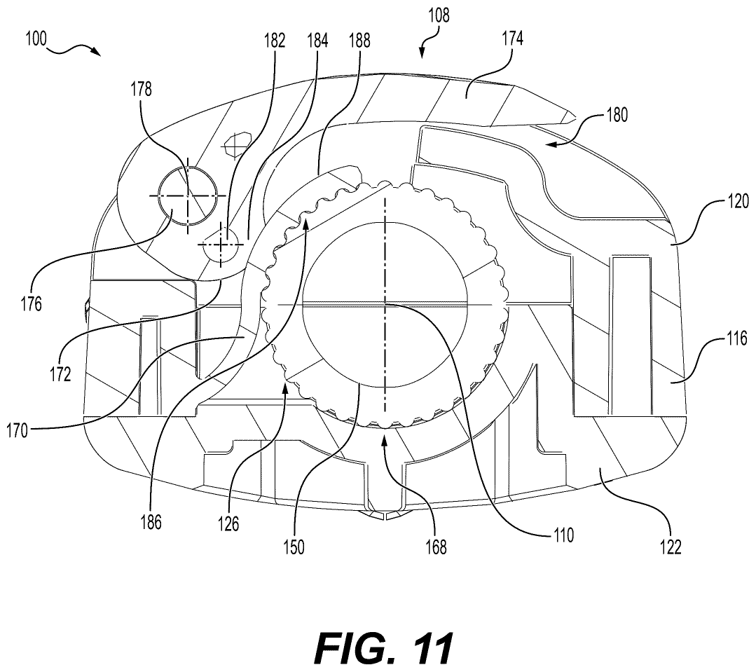

The cylindrical portion 150 has an upper flange 164, a lower flange 166 below the flange 164, and a dentate surface 168 below the lower flange 166. The dentate surface 168 is received in the recess 126 defined in the head portion 116 of the anchor body 112. The lower flange 166 is received in an annular recess 169 defined in the head portion 116 and that extends radially outward from the recess 126. As such, the cylindrical portion 150, and therefore the accessory connector 106, is rotatable about the rotation axis 110, but cannot move along the rotation axis 110, therefore preventing the accessory connector 106 from becoming disconnected from the anchor 104. A central axis of the cylindrical portion 150 is coaxial with the rotation axis and will therefore not be labeled separately. The flange 164 abuts a top of the head portion 116 of the anchor body 112 and caps a top of the recess 126. The dentate surface 168 of the cylindrical portion 150 has a plurality of rounded teeth that extend axially along the cylindrical portion 150 as best shown in FIGS. 11, 14, 16 and 17. It is contemplated that the teeth could have a different shape. It is also contemplated that the dentate surface 168 could be defined by a plurality of notches in the cylindrical portion 150.

The accessory lock 108 will now be described. The accessory lock 108 has a member 170 connected to the head portion 116 of the anchor body 112, a cam 172 pivotally connected to the head portion 116 of the anchor body 112, and an accessory lock lever 174 (hereinafter the lever 174) connected to the cam 172.

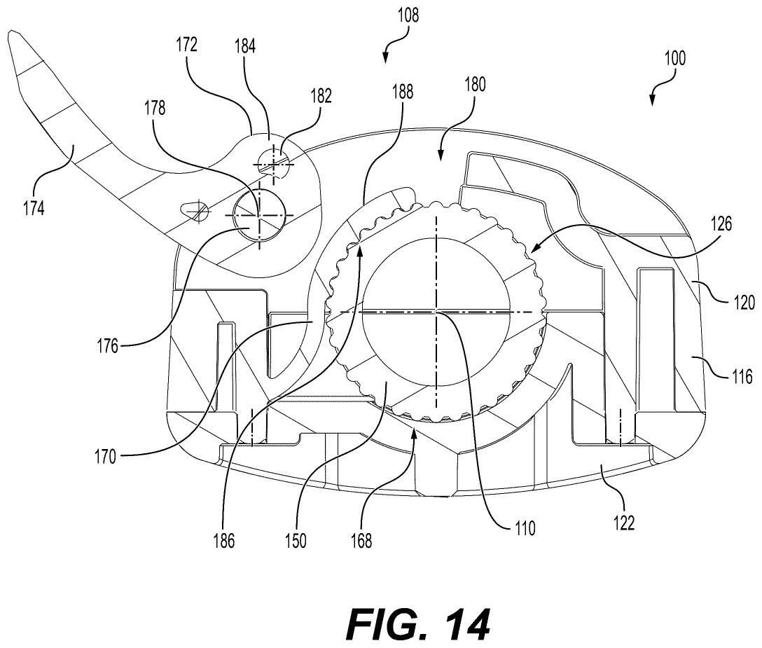

The cam 172 is pivotally connected to the head portion 116 of the anchor body 112 by a pin 176. The pin 176 defines an accessory lock axis 178. The accessory lock axis 178 is parallel to the rotation axis 110 and to the anchor lock axis 146. In the present embodiment, the lever 174 is integrally formed with the cam 172. As such, the lever 174 and the cam 172 pivot together about the accessory lock axis 178. It is contemplated that in other embodiments, the lever 174 could be connected to the cam 172 differently, such as by one or more fasteners. The cam 172 and the lever 174 are received in a recess 180 defined in the main portion 120 of head portion 116 of the anchor body 112 above the recess 138 that receives the anchor lock lever 128. As can be seen in FIGS. 11 and 14, the cam 172 has an aperture 182 therethrough that creates a hollow deformable portion 184 of the cam 172.

With reference to FIGS. 11 and 14, the member 170 has a dentate surface 186 that faces the dentate surface 168 of the cylindrical portion 150 of the accessory connector 106. As can be seen, the dentate surface 186 is configured to engage the dentate surface 168. The dentate surface 186 of the member 170 has a plurality of rounded teeth. It is contemplated that the teeth could have a different shape. It is also contemplated that the dentate surface 186 could be defined by a plurality of notches in the member 170. The member 170 has a smooth surface 188 opposite the dentate surface 186. The member 170 is an arcuate arm that generally follows the curvature of the cylindrical portion 150 of the accessory connector 106. The member 170 is integrally formed with the main portion 120 of the head portion 116 of the anchor body 112. It is contemplated that in alternative embodiments, the member 170 could be connected to the head portion 116 differently, such as by one or more fasteners. The member 170 is resilient and is biased toward the cylindrical portion 150.

The cam 172 and the lever 174 are pivotable between a locked position, shown in FIGS. 6 to 11 and 15, and an unlocked position, shown in FIGS. 12 to 14. As will be explained in greater detail below, in the locked position of the cam 172 and the lever 174, the accessory lock 108 restricts the rotation of the accessory connector 106 about the rotation axis 110, and in the unlocked position of the cam 172 and the lever 174, the accessory lock 108 permits rotation of the accessory connector 106 about the rotation axis 110. With reference to FIGS. 6 and 12, it can be seen that the cam 172 and the lever 174 pivot from the locked position (FIG. 6) to the unlocked position (FIG. 12) in a direction that is opposite to the direction in which the lever 128 is pivoted from its locked position (FIG. 6) to its unlocked position (FIG. 12).

With reference to FIG. 11, in the locked position of the cam 172 and the lever 174, the cam 172 pushes against the surface 188 thereby pressing the member 170 against the cylindrical portion 150 such that the dentate surface 186 of the member 170 engages the dentate surface 168 of the cylindrical portion 150. As a result, the rotation of the accessory connector 106 about the rotation axis 110 is restricted. However, in the present embodiment, rotation of the accessory connector 106 about the rotation axis 110 is not completely prevented. If no or little torque is applied to the cylindrical portion 150, the accessory connector 106 does not rotate about the rotation axis 110. If sufficient torque is applied to the cylindrical portion 150 of the accessory connector 106 (i.e. a torque above a threshold torque), the teeth of the dentate surface 168 of the cylindrical portion 150 slide against the teeth of the dentate surface 186 of the member 170, which pushes the member 170 again the cam 172, thereby deforming the deformable portion 184 of the cam 172, and the accessory connector 106 rotates about the rotation axis 110. When this torque stops being applied, the deformable portion 184 returns to its previous shape, pushing the dentate surface 186 of the member 170 against the dentate surface 168 of the cylindrical portion 150, once again restricting rotation of the accessory connector 106 about the rotation axis 110. When the cam 172 and the lever 174 are in the locked position, the accessory connector 106 will only rotate about the rotation axis 110 if a torque above the aforementioned threshold torque is applied. In the illustrated embodiment, the accessory lock 108, and in particular the cam 172, the member 170 and the cylindrical portion 150, are calibrated such that normal use of the watercraft 10 or another type of vehicle will not result in the torque applied being above the aforementioned threshold, but that an operator could manually apply a torque above that threshold if desiring to rotate the camera 102. It is contemplated that is some embodiments, the accessory lock 108 could be configured such that when the cam 172 and the lever 174 are in the locked position, the rotation of the accessory connector 106 about the rotation axis 110 is fully restricted (i.e. prevented) such that no torque other than a torque sufficiently high to break an element of the accessory lock 108 would allow the accessory connector 106 to rotate about the rotation axis 110.

With reference to FIG. 14, in the unlocked position of the cam 172 and the lever 174, the cam 172 applies no pressure against the member 170. As such, the only pressure applied by the dentate surface 186 of the member 170 onto the dentate surface 168 of the cylindrical member 150 is the result of the bias of the member 170 toward the cylindrical member 150. This pressure is small and the restriction resulting from the engagement of the dentate surfaces 168, 186 can be easily overcome by applying a small torque to the cylindrical portion 150. As such, rotation of the accessory connector 106 about the rotation axis 110 is permitted. It is contemplated that in some embodiments, in the unlocked position of the cam 172 and the lever 174, the cam 172 could apply some pressure against the member 170, but less pressure than in the locked position, such that the accessory connector 106 can be rotated about the rotation axis 106 by applying less torque to the cylindrical portion 150 than is necessary to turn the accessory connector 106 when the cam 172 and the lever 174 are in the locked position. It is contemplated that in some embodiments, when the cam 172 and the lever 174 are in the unlocked position, the member 170 makes no contact with the cylindrical portion 150. However, by having the dentate surface 186 engage the dentate surface 168 when the cam 172 and the lever 174 are in the unlocked position, the accessory connector 106 stays in position when no external torque is applied to it, thus keeping the accessory connector 106 in position until the cam 172 and the lever 174 are moved to the locked position.

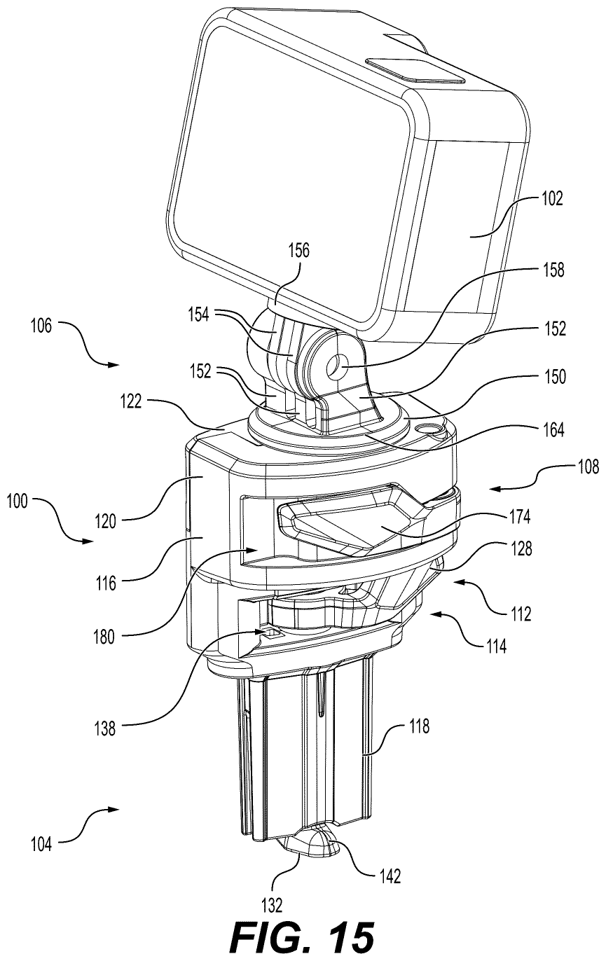

As such, with the accessory lock 108, the accessory connector 106 can be turned about the rotation axis 110 in two different ways. For example, to turn the accessory connector 106 and the camera 102 from the position shown in FIG. 6 to the position shown in FIG. 15, the user can first move the cam 172 and the lever 174 from the unlocked position to the locked position, then apply torque to the cylindrical portion 150 about the rotation axis 110 (by applying torque to the camera 102 for example) until the position shown in FIG. 15 is reached, and then moving the cam 172 and the lever 174 back to the locked position. Alternatively, the accessory connector 106 and the camera 102 can be turned from the position shown in FIG. 6 to the position shown in FIG. 15 by keeping the cam 172 and the lever 174 in the locked position by applying a greater amount of torque to the cylindrical portion 150 than is necessary when the cam 172 and the lever 174 are in the unlocked position.

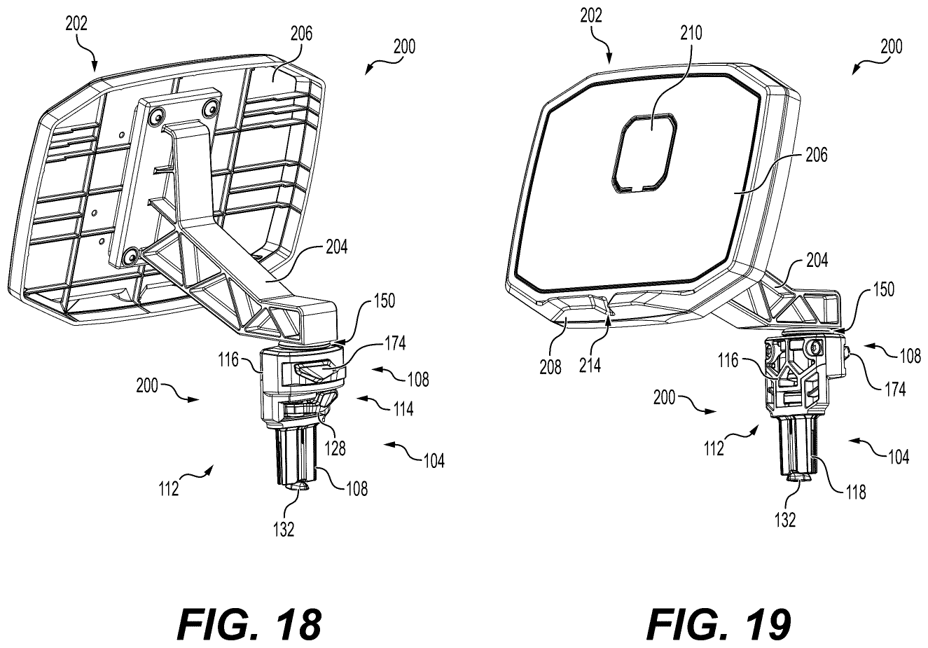

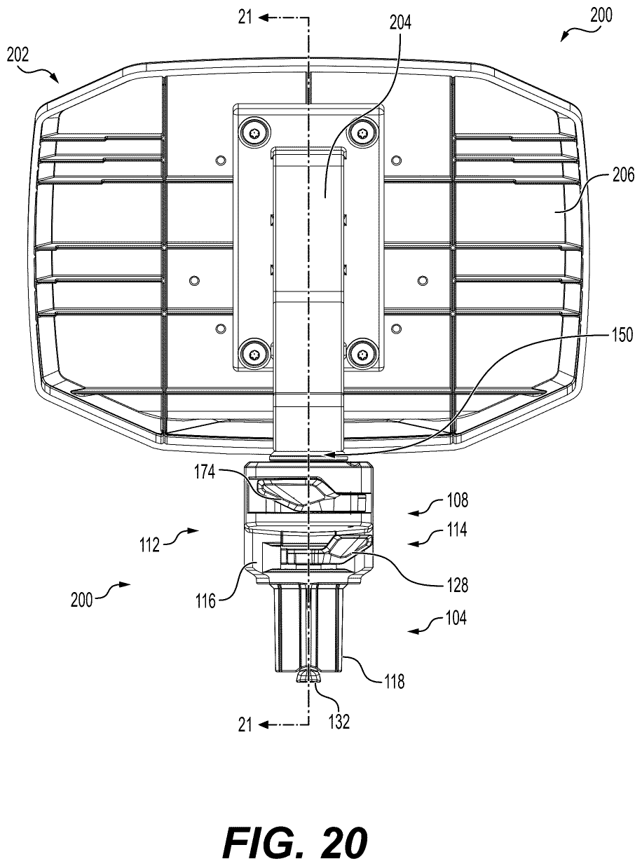

Turning now to FIGS. 18 to 21, an accessory holder 200 will be described. The accessory holder 200 has the same anchor 104 and accessory lock 108 as the accessory holder 100. As such, features of the accessory holder 200 that are the same as those of the accessory holder 100 have been labeled with the same reference numerals and will not be described again in detail. Instead of the accessory connector 106, the accessory holder 200 has an accessory connector 202. The accessory connector 202 is configured to connect to an electronic tablet.

The accessory connector 202 has a cylindrical portion 150 like the cylindrical portion 150 of the accessory connector 106. The cylindrical portion 150 of the accessory connector 202 is received in the anchor 104 and cooperates with the accessory lock 108 in the same way as the cylindrical portion 150 of the accessory connector 106 described above for the accessory holder 100. As such, the accessory connector 202 can be rotated relative to the anchor 104 in the way described above that is used to rotate the accessory connector 106 relative to the anchor 104 in the accessory holder 100.

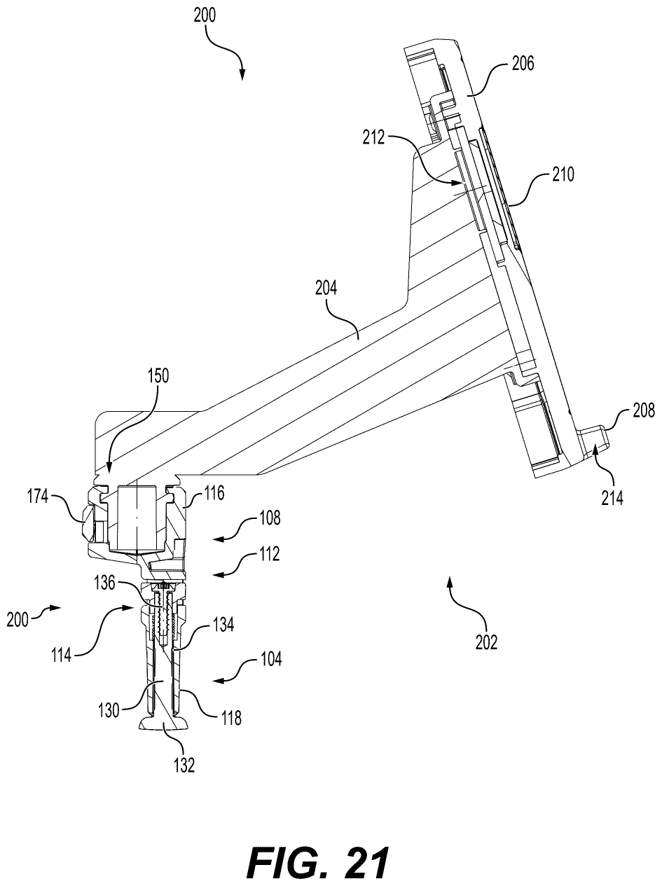

The accessory connector 202 has an arm 204 connected to the cylindrical portion 150. The arm 204 connects to a panel 206. A lip 208 extends from a bottom of the panel 206. A metallic plate 210 is recessed in the panel 206. Magnets 212 (FIG. 21) are provided under the metallic plate 210.

To connect an electronic tablet to the accessory connector 202, the bottom of the electronic tablet is placed over the lip 208 and the back of the electronic tablet is placed against the panel 206 and the metallic plate 210. The magnetic forces generated by the magnets 212 attract the electronic tablet against the metallic plate 210, thereby connecting the electronic tablet to the accessory connector 202. It is contemplated that in order to be attracted to the magnets 212, the electronic tablet may need to be provided with a metallic portion and/or magnets that will interact with the magnets 212 of the accessory connector 202. The metallic portion and/or these magnets can be adhered to the back of the electronic tablet or could be provided in a protective case of the electronic tablet. The lip 208 has a notch 214 that permits the passage of a charging cable to be connected to the charging port in the bottom of the electronic tablet when the electronic tablet is connected to the accessory connector 202.

Modifications and improvements to the above-described embodiments of the present invention may become apparent to those skilled in the art. The foregoing description is intended to be exemplary rather than limiting. The scope of the present technology is therefore intended to be limited solely by the appended claims.

What is claimed is:

1. An accessory holder for connecting an accessory to a support, the support defining an aperture, the accessory holder comprising:
an anchor being configured to be inserted in the aperture defined in the support and for selectively connecting the accessory holder to the support;
an accessory connector connected to the anchor, the accessory connector being rotatable about a rotation axis, the accessory connector being configured for connecting to the accessory, the accessory connector having a cylindrical portion received at least in part in the anchor, the cylindrical portion having a dentate surface, a central axis of the cylindrical portion being coaxial with the rotation axis; and
an accessory lock operatively connected to the anchor, the accessory lock comprising:
a member connected to the anchor, the member having a dentate surface facing the dentate surface of the cylindrical portion, the dentate surface of the member being configured to engage the dentate surface of the cylindrical portion; and
a cam operatively connected to the anchor, the cam being movable between a locked position and an unlocked position,
in the locked position of the cam, the cam pressing the member against the cylindrical portion such that the dentate surface of the member engages the dentate surface of the cylindrical portion for restricting rotation of the accessory connector about the rotation axis,
in the unlocked position of the cam, the cam applying less pressure against the member than in the locked position for permitting rotation of the accessory connector about the rotation axis.

2. The accessory holder of claim 1, wherein:
in the locked position, the accessory connector rotates about the rotation axis only in response to a torque greater than a first torque being applied to the cylindrical portion about the rotation axis;
in the unlocked position, the accessory connector rotates about the rotation axis in response to a torque greater than a second torque being applied to the cylindrical portion about the rotation axis; and
the first torque is greater than the second torque.

3. The accessory connector of claim 2, wherein:
the cam has a deformable portion; and
in the locked position, in response a torque greater than the first torque being applied to the cylindrical portion, the cylindrical portion pushing the member against the cam and the deformable portion of the cam being deformed.

4. The accessory connector of claim 3, wherein the deformable portion is hollow.

5. The accessory connector of claim 1, wherein the dentate surface of the cylindrical portion comprises a plurality of rounded teeth.

6. The accessory connector of claim 1, wherein the dentate surface of the member comprises a plurality of rounded teeth.

7. The accessory connector of claim 1, wherein the member is an arcuate arm.

8. The accessory connector of claim 1, wherein the member is integrally formed with the anchor.

9. The accessory connector of claim 1, wherein the cam is pivotable between the locked position and the unlocked position.

10. The accessory connector of claim 9, wherein the cam is pivotable between the locked position and the unlocked position about an accessory lock axis, the accessory lock axis being parallel to the rotation axis.

11. The accessory connector of claim 1, wherein the accessory lock further comprises a lever connected to the cam for moving the cam between the locked position and the unlocked position.

12. The accessory connector of claim 11, wherein the lever is integrally formed with the cam.

13. The accessory connector of claim 11, wherein the lever and the cam are pivotable between the locked position and the unlocked position about an accessory lock axis, the accessory lock axis being parallel to the rotation axis.

14. The accessory connector of claim 1, wherein the anchor comprises:
an anchor body configured to be received in the aperture of the support; and
an anchor lock movably connected to the anchor body,
the anchor lock having a locked position for connecting the anchor to the support, and
the anchor lock having an unlocked position for permitting removal of the anchor body from the aperture in the support and for permitting insertion of the anchor body in the aperture in the support.

15. The accessory connector of claim 14, wherein the anchor lock has an anchor lock lever for moving the anchor lock between the locked position and the unlocked position.

16. The accessory connector of claim 15, wherein:
the anchor lock has at least one anchor lock cam connected to and movable with the anchor lock lever; and
the anchor body has a portion disposed between the anchor lock lever and the at least one anchor lock cam.

17. The accessory connector of claim 16, wherein:
the anchor lock lever and the anchor lock cam are pivotable about an anchor lock axis between the locked position and the unlocked position; and
the anchor lock axis being parallel to the rotation axis.

18. An accessory holder for connecting an accessory to a support, the support defining an aperture, the accessory holder comprising:
an anchor being configured to be inserted in the aperture defined in the support and for selectively connecting the accessory holder to the support;
an accessory connector connected to the anchor, the accessory connector being rotatable about a rotation axis, the accessory connector being configured for connecting to the accessory; and
an accessory lock operatively connected to the anchor,
the accessory lock comprising an accessory lock lever operatively connected to the anchor, the accessory lock lever being movable between a locked position and an unlocked position,
in the locked position of the accessory lock lever, the accessory lock restricting rotation of the accessory connector about the rotation axis,
in the unlocked position of the accessory lock lever, the accessory lock permitting rotation of the accessory connector about the rotation axis;
the anchor comprising:
an anchor body configured to be received in the aperture of the support; and
an anchor lock movably connected to the anchor body,
the anchor lock comprising an anchor lock lever operatively connected to the anchor, the anchor lock lever being movable between a locked position and an unlocked position,
the locked position of the anchor lock lever being for connecting the anchor to the support, and
the unlocked position of the anchor lock lever being for permitting removal of the anchor body from the aperture in the support and for permitting insertion of the anchor body in the aperture in the support.

19. The accessory holder of claim 18, wherein:
the accessory lock lever is pivotable about an accessory lock axis between the locked position and the unlocked position;
the anchor lock lever is pivotable about an anchor lock axis between the locked position and the unlocked position; and
the accessory lock axis and the anchor lock axis are parallel to the rotation axis.

20. The accessory holder of claim 19, wherein:
the accessory lock lever pivots in a first direction from the locked position to the unlocked position;
the anchor lock lever pivots in a second direction from the locked position to the unlocked position; and
the first direction is opposite the second direction.
